(19) United States
(12) Patent Application Publication
(10) Pub. No.: US 2009/0026025 A1
(43) Pub. Date: Jan. 29, 2009

(54) DUAL COATED CAST IRON BRAKE ROTOR AND METHOD OF CONSTRUCTION

(76) Inventor: Keith Hampton, Ann Arbor, MI (US)

Correspondence Address: ROBERT L. STEARNS;Dickinson Wright PLLC, 38525 Woodward Avenue, Ste. 2000, Bloomfield Hills, MI, 48304-2970, US

(21) Appl. No.: 11/828,508

(22) Filed: Jul. 26, 2007

(51) Int. Cl. F16D 65/12; B23P 17/00

(52) U.S. Cl. 188/218 XL; 29/527.2

(57) ABSTRACT

A brake rotor for a vehicle and method of construction thereof provides a cast iron disc with a first coating of a ceramic anti-wear material adhered to the cast iron disc to provide an annular friction surface for braking engagement with a brake pad. The disc has a second coating different from the first coating. The second coating is adhered to the disc to provide an annular non-braking surface spaced from the friction surface. The non-braking surface provided by the second coating is resistant to corrosion.

### BACKGROUND OF THE INVENTION

1. Technical Field

This invention relates generally to brake rotors, and more particularly to cast iron brake rotors.

2. Related Art

Cast iron brake rotors are used widely on vehicles for several reasons, including relatively low cost, relatively high thermal conductivity, its ability to be readily machined, and its ability to resist cracking in use. However, cast iron is susceptible to corrosion when exposed to moisture and other chemicals encountered from ground surfaces, such as road salt, for example. The ensuing corrosion layer results in a reduced coefficient of friction and increased layer thickness on the outer surface of the brake rotor. As such, interference between the corrosion layer and an adjacent brake pad can result, thereby causing undesirable feedback through the brake system to the driver, and noise.

In order to overcome the problems associated with corrosion, corrosion resistant coatings have been applied to brake surfaces of the rotors. Although the anticorrosion coating can be effective to initially reduce corrosion, they are typically not well suited to provide wear protection. In addition, anti-wear coatings typically have a reduced melt point temperature, and thus, can result in unwanted asperities beneath a brake pad, thereby producing unwanted vibration, noise and wear in use.

### SUMMARY OF THE INVENTION

A brake rotor for a vehicle constructed in accordance with one aspect the invention includes a cast iron disc with a first coating of a ceramic anti-wear material adhered to the cast iron disc to provide an annular friction surface for braking engagement with a brake pad. The disc also has a second coating different from the first coating. The second coating is adhered to the disc to provide an annular non-braking surface spaced from the friction surface. The non-braking surface provided by the second coating is resistant to corrosion.

Accordingly to another aspect of the invention, the rotor can include a nickel-based intermediate layer between the first coating and the disc. Further, the nickel-based coating can be provided as pure nickel.

According to yet another aspect of the invention, the first coating can be provided as an alumina-based material. Further yet, the first coating can be provided as pure alumina.

According to another aspect of the invention, a method of constructing a brake rotor for a vehicle is provided. The method includes providing a cast iron disc having braking surface portions on opposite sides of the disc and non-braking portions. Next, machining the braking surface portions and applying a nickel-based intermediate coating on the braking surface portions. Further, the method includes applying an alumina-based anti-wear coating on the intermediate coatings and applying a corrosion resistant coating to the non-braking surface portions of the disc.

Accordingly, a brake rotor constructed in accordance with the invention is resistant to wear in use, resists corrosion both on the wear and non-wear surfaces, has a comparatively long and useful life, is environmentally friendly in manufacture, and among other things, is economical in manufacture and in use.

### BRIEF DESCRIPTION OF THE DRAWINGS

These and other aspects, features and advantages of a brake rotor constructed in accordance with the present invention will become more readily appreciated when considered in connection with the following detailed description of presently preferred embodiments and best mode, appended claims and accompanying drawings, in which:

FIG. 1 is a plan view of a brake rotor constructed according to one presently preferred embodiment of the invention; and

FIG. 2 is cross-sectional view taken generally along line 2-2 of FIG. 1.

### DETAILED DESCRIPTION OF PRESENTLY PREFERRED EMBODIMENTS

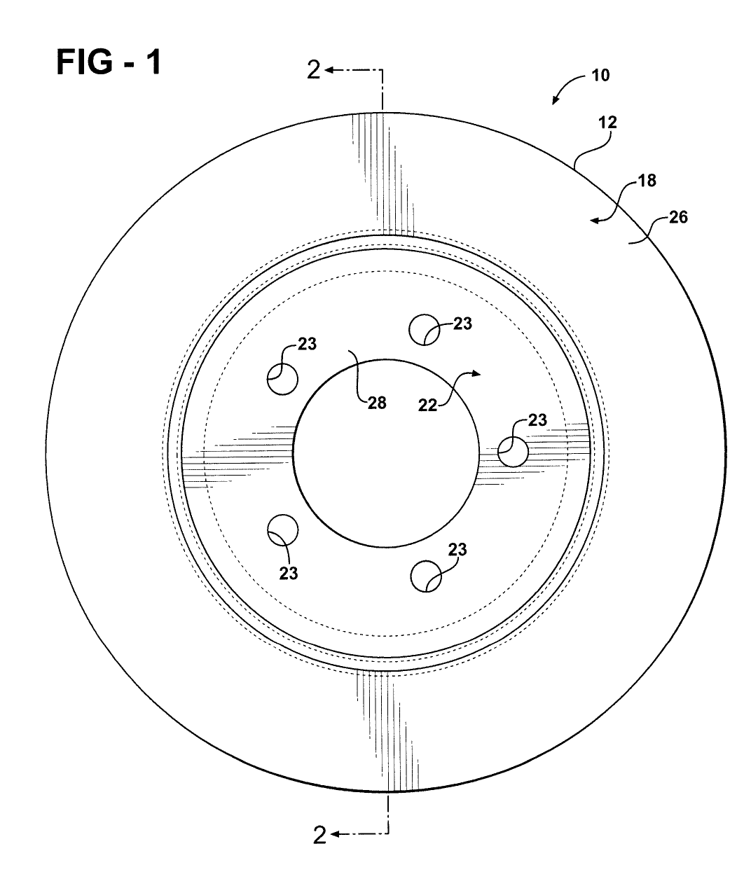

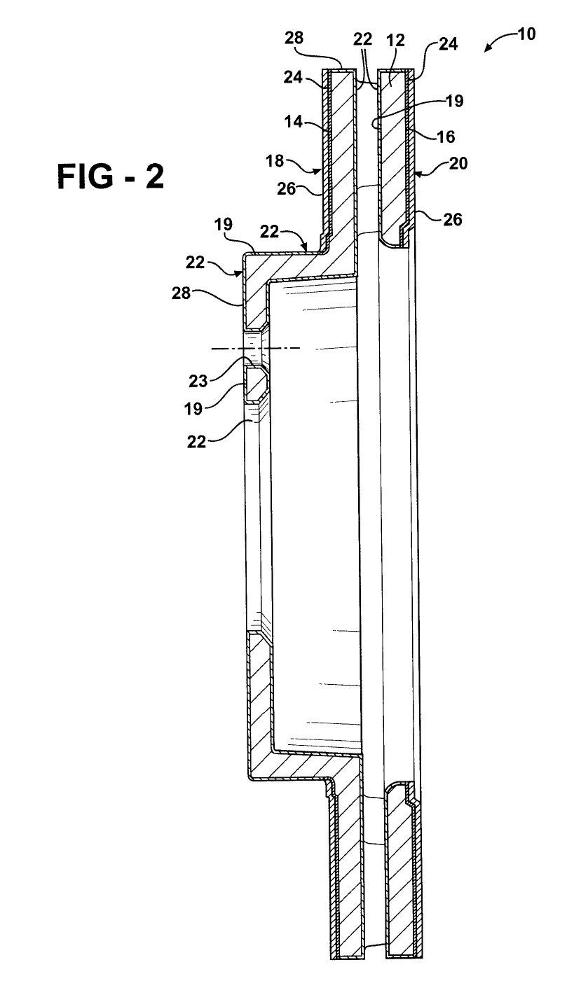

Referring in more detail to the drawings, FIGS. 1 and 2 illustrate a cast iron brake rotor 10 constructed according to one presently preferred embodiment of the invention. The brake rotor 10 is constructed from a cast iron disc 12 having opposite sides 14, 16 (FIG. 2) with annular friction surfaces 18, 20 providing braking engagement with opposed brake pads (not shown). Other than the friction surfaces, 18, 20, the rotor 10 also has non-braking surfaces 22 spaced from the braking friction surfaces 18, 20 that do not come into contact with the brake pads during braking. The friction surfaces 18, 20 are constructed to resist wear, and the non-braking surfaces 22 are protected constructed to resist corrosion. Accordingly, the useful life of the brake rotor 10 is enhanced.

In constructing the brake rotor 10, the opposite sides 14, 16 of the disc 12 are machined to the general size and shape of the finished brake rotor, wherein bolt openings 23 are formed, and the sides 14, 16 are formed to a desired thickness. Upon completing the machining, the disc 12 is preferably washed to remove any grease and other fluids and/or contamination present from the machining process.

To facilitate further construction of the rotor 10, the opposite sides, also referred to as annular braking surface areas or portions 14, 16, that will become the friction surfaces 18, 20 can be roughened, such as in a sand or glass bead blasting process, for example. It should be recognized that other processes can be utilized to roughen the surfaces, such as chemical etching, for example. During the roughening process, areas to remain unaffected, such as areas 19 beneath the non-braking surfaces 22, for example, can be masked to prevent their being roughened.

Upon roughening the annular braking surface portions 14, 16 of the disc 12, a bond coat layer of adhesion promoting material 24 is coated thereon. The bond coat of adhesion promoting material 24 is preferably performed using a nickel alloy material, and more preferably, with pure nickel material. The material 24 is preferably applied to the annular friction braking areas 14, 16 only, and not on the remaining non-braking surfaces 19 of the disc 12. As such, to prevent the material 24 from being applied outside of the friction braking areas, the disc could be masked. The material 24 can be applied having a finished thickness of about 10-100 μm, and preferably about 15-60 μm, and more preferably about 20-30 μm.

Next, upon applying the adhesion promoting material 24, a first coating of a ceramic anti-wear material layer 26 is applied to the disc 12 over the adhesion promoting layer 24. The coating of anti-wear material 26 is preferably performed using pure alumina material, although other anti-wear materials could be used, if desired for the intended application. For example, an alumina alloy material could be used, wherein titanium, zirconium, oxygen and other contaminants could be incorporated into the alumina alloy material. The anti-wear material 26 can be applied having a finished thickness of about 100-400 μm, and preferably about 150-250 μm.

Upon completing application of the anti-wear material 26 to the disc 12, a second coating of an anti-corrosion material 28 is adhered to the disc 12. The coating of anti-corrosion material 28 is applied over the non-braking surfaces 19 of the disc 12 spaced from the anti-wear material 26, and can be applied so that the entire disc 12, other than the friction surfaces 18, 20 are covered with the material 28. The anti-corrosion material 28 is preferably applied using pure nickel material, although other anti-corrosion materials could be used, if desired for the intended application. For example, a nickel alloy material could be used. The anti-corrosion material 26 can be applied having a finished thickness that is generally flush with the adjacent anti-wear material 26, and thus, can range between about 110-500 μm, and preferably about 170-280 μm. Upon adhering the anti-corrosion material 28 to the disc 12, an outer cure coating can be applied on the non-braking surfaces 22.

To achieve the desired thickness and surface finish roughness of the anti-wear material 26, the friction surfaces 18, 20 can be ground, such as in a double disc grinding process, for example, using diamond wheels. The surface finish of the anti-wear material is preferably about 1.6 μm or less, although in some instances it may be beneficial to provide a surface finish up to about 5 μm. The grinding process can be performed immediately after applying the anti-wear material 26, or at anytime thereafter, preferably as a last step.

The brake rotor 10, in accordance with another aspect of the construction, can be fabricated by altering the order of processes. For example, rather than adhering the bond coat of adhesion promoting material 24 after machining the disc 12, the annular braking surface areas 14, 16 of the friction surfaces can be masked, and then the anti-corrosion material 28 can be adhered to the unmasked, non-braking surfaces 22 of the disc 12. Then, while still masked, an outer cure coating can be applied on over the anti-corrosion material.

Upon applying the cure coating, the masking can then be removed, and masking can then be applied over the non-braking surfaces 22. Then, the annular braking surface areas 14, 16 can be roughened, as described above, and the adhesion promoting material 24 can be applied to the roughened surfaces. Then, the anti-wear material 26 can be applied on the adhesion promoting material 24 to form the friction surfaces 18, 20. As above, the anti-wear material 26 can then be ground to the desired thickness and surface finish.

In yet another presently preferred method of constructing the rotor 10, the anti-corrosion material 28 can be first applied to the disc 12 over its entire surface, and then the braking surfaces 14, 16 can be machined to the desired thickness. Then, the non-braking surfaces 22 can be masked, and the adhesion promoting material 24 can be applied over the braking surfaces 14, 16. Then, the anti-wear material 26 can be applied over the adhesion promoting material 24, then machined to the desired surface finish.

Obviously, many modifications and variations of the present invention are possible in light of the above teachings. It is, therefore, to be understood that within the scope of the appended claims, the invention may be practiced otherwise than as specifically described.

What is claimed is:

1. A brake rotor, comprising:
a cast iron disc;
a first coating of a ceramic anti-wear material adhered to said cast iron disc, said first coating providing an annular friction surface for braking engagement with a brake pad; and
a second coating different from said first coating adhered to said cast iron disc, said second coating providing an annular non-braking surface spaced from the friction surface and being resistant to corrosion.

2. The brake rotor of claim 1 further comprising a nickel-based bond coat disposed between said first coating and said cast iron disc.

3. The brake rotor of claim 2 wherein said nickel-based bond coat consists of pure nickel.

4. The brake rotor of claim 3 wherein said first coating consists of alumina.

5. The brake rotor of claim 3 wherein said first coating consists of an alumina-based alloy.

6. The brake rotor of claim 3 wherein the alloy material consists of one of titanium, zirconium, oxygen.

7. The brake rotor of claim 4 wherein said bond coat has a thickness between about 10-100 μm.

8. The brake rotor of claim 7 wherein said bond coat has a thickness between about 15-60 μm.

9. The brake rotor of claim 8 wherein said bond coat has a thickness between about 20-30 μm.

10. The brake rotor of claim 7 wherein said first coating has a thickness between about 100-400 μm.

11. The brake rotor of claim 8 wherein said first coating has a thickness between about 150-250 μm.

12. The brake rotor of claim 9 wherein said first coating has a thickness between about 150-250 μm.

13. The brake rotor of claim 4 wherein said second layer comprises at least one of epoxy-based paint, lacquer paint, or a water-based coating dispersion containing metal oxides, metallic zinc and aluminum flakes.

14. The brake rotor of claim 1 wherein said first coat has a surface finish less than 1.6 μm.

15. The brake rotor of claim 1 wherein said first coat has a surface finish of about 5 μm.

16. A method of constructing a disc brake rotor for a vehicle, comprising:
providing a cast iron disc having annular braking surface portions on opposite sides of said disc and non-braking portions;
machining said braking surface portions;
applying a nickel-based intermediate coating on said braking surface portions;
applying an alumina-based wear coating on said intermediate coatings; and
applying a corrosion resistant coating to said non-braking surface portions of said disc.

17. The method of claim 16 further including roughening said braking surface portions after the machining step and prior to applying the intermediate coatings.

18. The method of claim 16 further including applying said corrosion resistant coating to said braking surface portions of said disc.

19. The method of claim 18 further including performing said machining step after applying said corrosion resistant coating.

20. The method of claim 16 further including grinding said alumina-based wear coating to a thickness of about 100-400 μm.

21. The method of claim 20 further including grinding said alumina-based wear coating to a thickness of about 150-200 μm.

22. The method of claim 20 further including grinding said alumina-based wear coating to a surface finish of about 5 μm.

23. The method of claim 20 further including grinding said alumina-based wear coating to a surface finish no greater than about 1.6 μm.

24. The method of claim 16 further including providing said intermediate coating as pure nickel.

25. The method of claim 24 further including providing said alumina-based wear coating as pure alumina.

26. The method of claim 16 further comprising applying a cure coating on said corrosion resistant coating.
